(19) United States
(12) Patent Application Publication
(10) Pub. No.: US 2024/0326549 A1
(43) Pub. Date: Oct. 3, 2024

(54) SOLAR POWERED TEMPERATURE MODULATION ASSEMBLY FOR MOTOR VEHICLE PASSENGER COMPARTMENT

(71) Applicants: Salvatore Paul Salmeri, Springfield, OR (US); Kevin Michael Kilpatrick, Dexter, OR (US)

(72) Inventors: Salvatore Paul Salmeri, Springfield, OR (US); Kevin Michael Kilpatrick, Dexter, OR (US)

(21) Appl. No.: 18/742,793

(22) Filed: Jun. 13, 2024

Related U.S. Application Data
(63) Continuation-in-part of application No. 18/094,551, filed on Jan. 9, 2023, now abandoned.
(62) Division of application No. 16/289,914, filed on Mar. 1, 2019, now Pat. No. 11,548,350.
(60) Provisional application No. 62/917,683, filed on Dec. 26, 2018.

(51) Int. Cl. B60H 1/00

(52) U.S. Cl. CPC B60H 1/00478; B60H 1/00264; B60H 1/00428; B60H 1/0075

(57) ABSTRACT

A temperature modulation assembly for a motor vehicle's passenger compartment includes an assembly panel having a single or a plurality of solar panels which convert sunlight into electricity and an assembly housing which includes an internal thermoelectric Peltier cooler having a heat sink on its cool side and a heat sink on its hot side and an internal fluid distribution module which draws air into the assembly housing, causes some of the air to be cooled by passing through the cool side heat sink and directed back into the passenger compartment and the rest of the air to be heated by passing through the hot side heat sink and directed back into the passenger compartment. The components of the assembly housing utilize electricity that originates at the assembly panel, and the assembly housing is structured to distribute cooled towards near the passenger seating and heated air towards the windshield.

### CROSS REFERENCE TO RELATED APPLICATIONS

This application is a continuation in part application of U.S. patent application Ser. No. 18/094,551, filed Jan. 9, 2023, which was a divisional application of U.S. patent application Ser. No. 16/289,914, filed Mar. 1, 2019 (now U.S. Pat. No. 11,548,350), which claimed the benefit of and incorporated by reference U.S. provisional patent application Ser. No. 62/709,255, filed Jan. 2, 2018, and co-pending U.S. provisional patent application Ser. No. 62/917,683 filed Dec. 26, 2018.

### BACKGROUND OF THE INVENTION

### Field of the Invention

This invention relates to a solar powered cooling and heating device for the passenger compartment of a motor vehicle.

### Description of the Prior Art

In modern times, it is common for many types of motor vehicles to include an enclosed passenger compartment that operates to provide, among other things, seating of the driver and passengers of the vehicle. For motor vehicles with such an enclosed passenger compartment, mechanisms for providing heating and cooling functionality are generally provided so that the internal environment of the compartment can be regulated as desired by the occupants. Because they generally require a substantial amount of power or energy to operate, however, such mechanisms for providing heating and cooling functionality typically only operate while a vehicle is in use. As a result, during the times when the vehicle is not in use, the passenger compartment can become very hot or cold depending on weather conditions. Therefore, a problem which still exists is that the passenger compartments of vehicles commonly become very hot or cold in between uses of the vehicle.

Accordingly, what is needed is a temperature modulation assembly for a motor vehicle's passenger compartment which uses electricity generated from solar radiation to power a thermoelectric cooler. It would additionally be desirable for such a temperature modulation assembly to employ fans to direct ambient air across both the cool side and the hot side of the thermoelectric cooler in a manner which causes the cooled air and heated air to automatically be strategically distributed in the vehicle.

### SUMMARY OF THE INVENTION

The present disclosure describes a temperature modulation assembly for a motor vehicle's passenger compartment, comprising: an assembly panel configured to convert sunlight into electricity; an assembly housing integral with said assembly panel and defining an enclosure having a lower internal portion, an upper internal portion, a front region and a pair of opposing side regions; a front vent integral with said front region; at least one side screen integral with at least one of said pair of opposing side regions; a thermoelectric Peltier cooler integral with said assembly housing and having a first side and a second side and configured to transfer heat from the first side to the second side when supplied with electricity that originated at the assembly panel, wherein said thermoelectric Peltier cooler is oriented such that the first side is positioned in said lower internal portion and said second side is positioned in said upper internal portion; and a fluid distribution module integral with said assembly housing and adapted to draw a fluid material into the assembly housing, cause a first portion of said fluid material to be cooled by operation of the first side of the thermoelectric Peltier cooler and directed out of the lower internal portion and the assembly housing, and cause a second portion of said fluid material to be heated by operation of the second side of the thermoelectric Peltier cooler and directed out of the upper internal portion and the assembly housing when supplied with electricity that originated at the assembly panel.

The fluid distribution module may comprise a cool side distribution fan and a hot side distribution fan which direct fluid material in the lower internal portion and upper internal portion, respectively, out of the front vent, and a pair of intake fans which draw fluid material into the lower internal portion and upper internal portion through the at least one side screen.

It is an object of this invention to provide a temperature modulation assembly for a motor vehicle's passenger compartment which uses electricity generated from solar radiation to power a thermoelectric cooler.

It is another object of this invention to provide a temperature modulation assembly for a motor vehicle's passenger compartment which employs fans to direct ambient air across both the cool side and the hot side of the thermoelectric cooler in a manner which causes the cooled air and heated air to automatically be strategically distributed in the vehicle.

These and other objects will be apparent to one of skill in the art.

### BRIEF DESCRIPTION OF THE DRAWINGS

FIG. 1 is a side perspective view of a temperature modulation assembly for a motor vehicle's passenger compartment built in accordance with a first embodiment of the present invention.

FIG. 2 is a back perspective view of a temperature modulation assembly for a motor vehicle's passenger compartment built in accordance with a first embodiment of the present invention shown positioned against a front windshield of a vehicle.

FIG. 3 is a side elevational view showing a cross section of assembly housing of a temperature modulation assembly for a motor vehicle's passenger compartment built in accordance with a first embodiment of the present invention.

FIG. 4 is a top plan view showing a cross section of the assembly housing of a temperature modulation assembly for a motor vehicle's passenger compartment built in accordance with a first embodiment of the present invention.

FIG. 5 is a schematic diagram showing the operational components of a temperature modulation assembly for a motor vehicle's passenger compartment built in accordance with a first embodiment of the present invention.

FIG. 6 is a side perspective view of a temperature modulation assembly for a motor vehicle's passenger compartment built in accordance with a second embodiment of the present invention.

FIG. 7 is a back perspective view of a temperature modulation assembly for a motor vehicle's passenger compartment built in accordance with a second embodiment of the present invention shown positioned against a front windshield of a vehicle.

FIG. 8 is a side elevational view showing a cross section of assembly housing of a temperature modulation assembly for a motor vehicle's passenger compartment built in accordance with a second embodiment of the present invention.

FIG. 9 is a top plan view showing a cross section of the assembly housing of a temperature modulation assembly for a motor vehicle's passenger compartment built in accordance with a second embodiment of the present invention.

FIG. 10 is a front elevational view showing a cross section of assembly housing of a temperature modulation assembly for a motor vehicle's passenger compartment built in accordance with a second embodiment of the present invention.

FIG. 11 is a schematic diagram showing the operational components of a temperature modulation assembly for a motor vehicle's passenger compartment built in accordance with a second embodiment of the present invention.

### DETAILED DESCRIPTION OF THE INVENTION

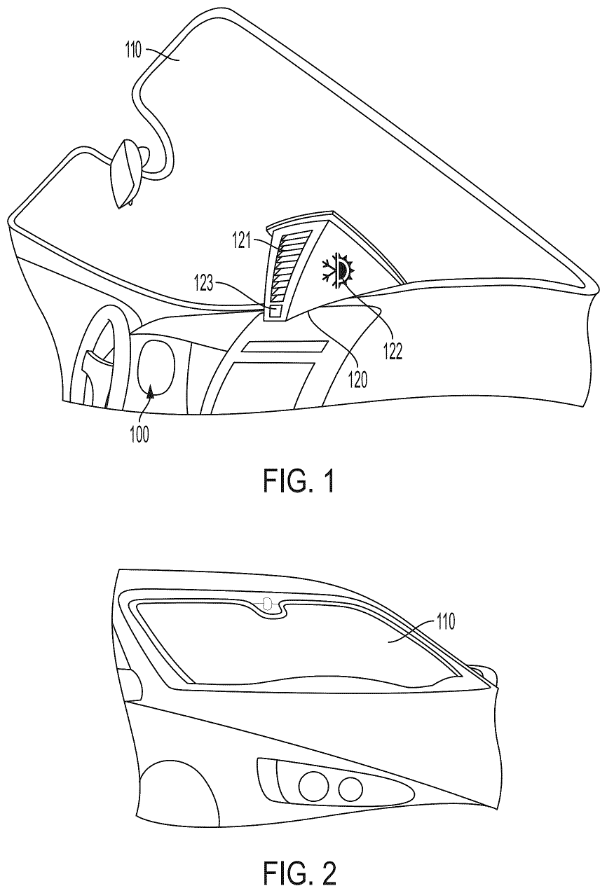

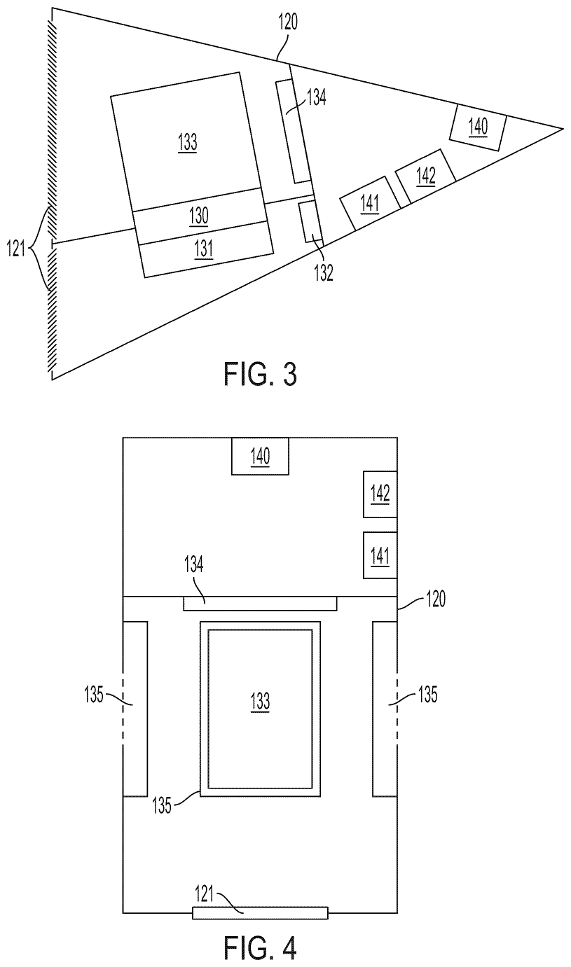

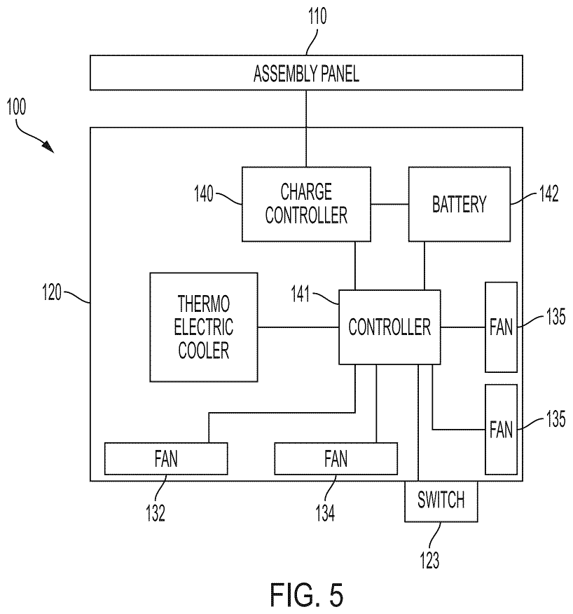

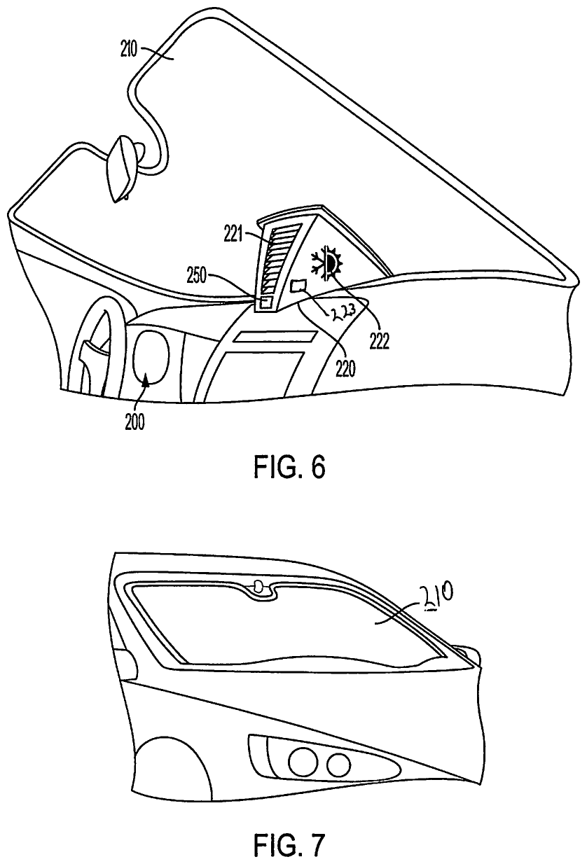

Referring now to the drawings and in particular FIGS. 1 and 2, a temperature modulation assembly 100 for a motor vehicle's passenger compartment is shown having an assembly panel 110 and an assembly housing 120. The assembly panel 110 may include a single or a plurality of solar panels which are operative to absorb photons in sunlight and create a photovoltaic effect that converts the sunlight into electricity. The components housed in the assembly housing 120 then utilize electricity to direct some air from in the vehicle over a cooling surface and then back into the vehicle and some air from in the vehicle over a warming surface and then back into the vehicle, as described below with reference to FIGS. 3-5.

Referring now to FIGS. 1, 2, 3, 4, and 5, the assembly housing 120 includes a plurality of temperature control components and a plurality of electrical control components. The temperature control components include a thermoelectric Peltier cooler 130, a cool side heat sink 131, a cool side distribution fan 132, a hot side heat sink 133, a hot side distribution fan 134, and a pair of intake fans 135. The electrical control components include a charge controller 140, a controller 141, and a battery 142. The exterior of the assembly housing 120 includes a front vent 121, a pair of side screens 122 each positioned on opposing sides of the assembly housing and disposed in a side wall of the assembly housing 120, and a manually actuated switch 123. While most of the side walls of the assembly housing 120 may be constructed of solid material, it is contemplated that the front vent 121 may include a plurality of fins to allow air to flow in and out of the front of the assembly housing 120 through the front vent 121 and side screens 122 may be formed of a mesh material to allow air to flow in and out of the sides of the assembly housing 120 through the side screens 122.

The interior of the assembly housing 120 may be divided by a divider wall 124 so as to form an upper compartment and a lower compartment. The fins of the front vent 121 which are in front of the upper compartment may be angled upward (i.e., directing away from the lower compartment) and the fins of the front vent which are in front of the lower compartment may be angled downward (i.e., directing away from the upper compartment). The divider wall 124 is positioned such that air flowing into the side screens 122 may enter the upper compartment or the lower compartment. Positioned next to each of the side screens 122 is one of the intake fans 135. When in provided with electricity, each intake fan 135 is operative to pull air from outside of the assembly housing 120 into the assembly housing 120 through the side screen 122 that it is positioned next to.

Integral with the divider wall 124 is the thermoelectric Peltier cooler 130, with the cool side thereof oriented to face the lower compartment of the assembly housing 120 and the opposing hot side thereof oriented to face the upper compartment of the assembly housing 120. It is appreciated that when the thermoelectric Peltier cooler 130 is supplied with direct current electricity, it brings heat from one side to the other. Accordingly, the “cool side” of the thermoelectric Peltier cooler 130, as referenced herein, refers to the side of the thermoelectric Peltier cooler 130 from which heat is brought and the “hot side” of the thermoelectric Peltier cooler 130, as referenced herein, refers to the side of the thermoelectric Peltier cooler 130 to which heat is brought.

The cool side heat sink 131 is attached to the cool side of the thermoelectric Peltier cooler 130 and extends downward into the lower compartment of the assembly housing 120. The cool side distribution fan 132 is positioned behind the cool side heat sink 131, so that when activated, it directs air across the cool side heat sink 131 and out of the lower part of the front vent 121. It is contemplated that when the cool side distribution fan 132 is activated, it is primarily the air flowing into the side screens 122 that enters the lower compartment that is being directed across the cool side heat sink 131 and out of the lower part of the front vent 121 by the cool side distribution fan 132.

The hot side heat sink 133 is attached to the hot side of the thermoelectric Peltier cooler 130 and extends upward into the upper compartment of the assembly housing 120. The hot side distribution fan 134 is positioned behind the hot side heat sink 133, so that when activated, it directs air across the hot side heat sink 133 and out of the upper part of the front vent 121. It is contemplated that when the hot side distribution fan 134 is activated, it is primarily the air flowing into the side screens 122 that enters the upper compartment that is being directed across the hot side heat sink 133 and out of the upper part of the front vent 121 by the hot side distribution fan 134.

The assembly panel 110 may be electrically connected to the assembly housing 120, and more particularly, to the charge controller 140 in the assembly housing 120. The charge controller 140 is electrically interconnected with the controller 141 and the battery 142 so that the charge controller 140 can manage the supply of electricity from the assembly panel 110 to the controller 141 and to the battery 142 and the storage of such electricity in the battery 142. In addition, the controller 141 is electrically connected to the thermoelectric Peltier cooler 130, cool side distribution fan 132, hot side distribution fan 134, intake fans 135, and switch 123 and includes software containing instructions which enables it to selectively supply electricity from either the charge controller 140 or battery 142 either automatically or in response to actuation of the switch 123. It is appreciated that the electrical connections between components may be through electrical wiring (not shown).

In operation, when the thermoelectric Peltier cooler 130, cool side distribution fan 132, hot side distribution fan 134, intake fans 135 are supplied electricity, the Peltier cooler 120 operates to absorb heat in the air that is being directed into the lower compartment of the assembly housing 120 by operation of the intake fans 135 and across the cool side heat sink 131 by operation of the cool side distribution fan 132. As a result, air that exits the lower part of the front vent 121 by operation of the cool side distribution fan 132 is cooled relative to most of the air in the passenger compartment. At the same time, air being directed into the upper compartment by operation of the intake fans 135 is directed across the hot side heat sink 133 by operation of the hot side distribution fan 134 where it absorbs heat therein (which was transferred from the cool side of the thermoelectric Peltier cooler 130 by way of the hot side of the thermoelectric Peltier cooler 130). This air is heated through its absorption of heat from the hot side heat sink 133 prior to exiting from the upper part of the front vent 121 by operation of the hot side distribution fan 134.

Because this cooled air will be more dense than the ambient air in the vehicle, it will remain in a lower part of the passenger compartment, near the passenger seating. Conversely, because the heated air will be less dense than the ambient air in the vehicle, it will run up the windshield and stay adjacent to the ceiling of the passenger compartment of the vehicle. As such, it is contemplated that the temperature modulation assembly 100 may additionally operate to prevent the formation or accumulation of frozen material on a windshield on a sunny but cold day.

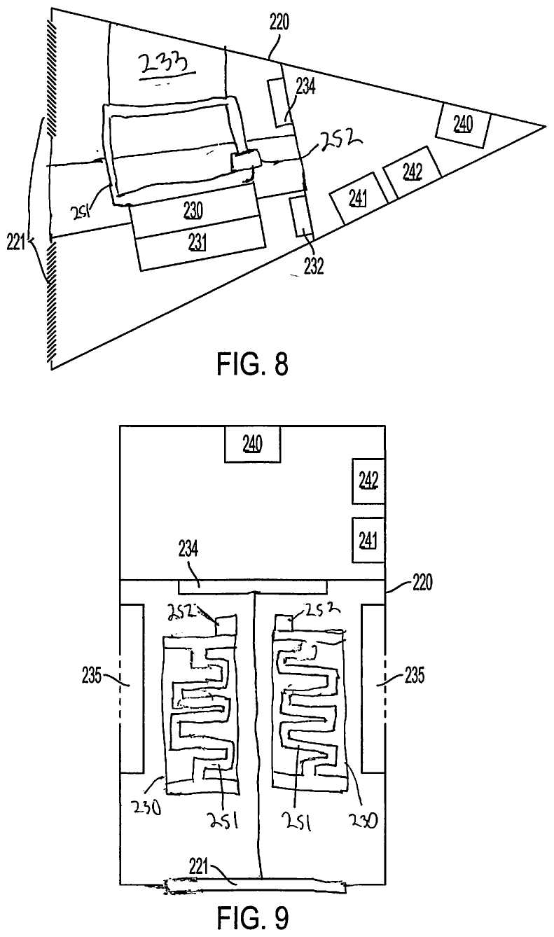

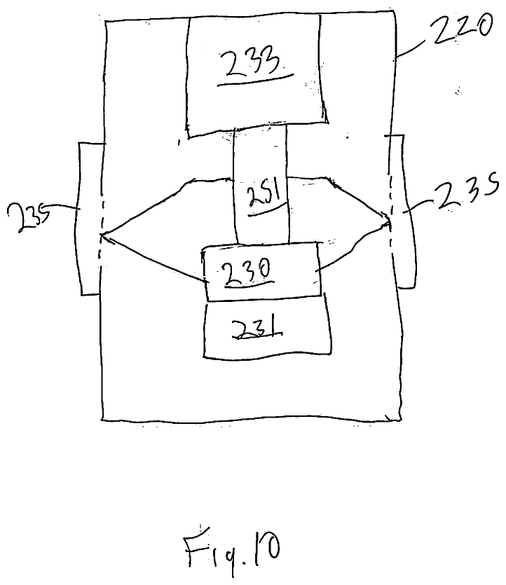

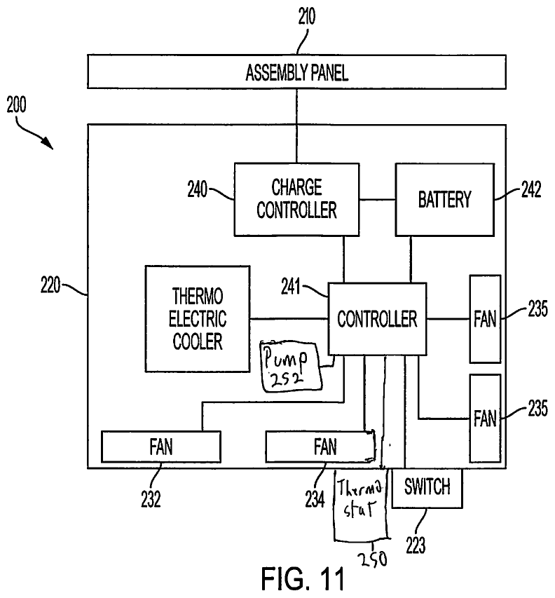

Referring now to FIGS. 6, 7, 8, 9, 10 and 11, in a second embodiment of the temperature modulation assembly 200, an assembly housing 220 again includes a plurality of temperature control components and a plurality of electrical control components. The temperature control components include a pair of thermoelectric Peltier coolers 230, a pair of cool side heat sinks 231, a pair of cool side distribution fans 232, a heat-transfer fluid system, a pair of hot side heat sinks 233, a pair of hot side distribution fans 234, and a pair of intake fans 235. The electrical control components include a charge controller 240, a controller 241, a battery 242, and a thermostat 250.

The exterior of the assembly housing 220 includes a plurality of front vents 221, a pair of side screens 222, positioned on opposing sides of the assembly housing and disposed in a side wall of the assembly housing 220, and a manually actuated switch 223. While most of the side walls of the assembly housing 220 may be constructed of solid material, it is contemplated that the front vents 221 may include a plurality of fins to allow air to flow in and out of the front of the assembly housing 220 through the front vent 221 and side screens 222 may be formed of a mesh material to allow air to flow in and out of the sides of the assembly housing 220 through the side screens 222.

The interior of the assembly housing 220 may be divided by several divider walls 224, collectively arranged to partition the interior of the assembly housing 220 into a left partition and a right partition, with the each of the left side partition and right side partition divided into an upper compartment, central compartment, and lower compartment. The left partition and right partition may each be assembled in essentially the same manner with respect to the presence of duplicate discrete temperature control components relative to the other partition. The discrete temperature control components of the left partition and right partition may be operatively connected to and share the same electrical control components.

The fins of the front vent 221 are in front of the respective upper compartments may be angled upward (i.e., directing away from the respective central and lower compartments) and the fins of the front vent which are in front of the respective lower compartments may be angled downward (i.e., directing away from the respective upper and central compartments). The divider walls 224 are positioned such that air flowing into the side screens 222 on a given side is directed in the upper compartments or the lower compartments of the given side. Positioned next to each of the side screens 222 is one of the intake fans 235. When in provided with electricity, each intake fan 235 is operative to pull air from outside of the assembly housing 220 into the assembly housing 220 through the side screen 222 that it is positioned next to.

It is contemplated that the divider walls 224 may be form from, and/or have attached thereto, a temperature insulating material such as an Ethylene-propylene diene monomer material which is fire-resistant, flame-retardant, high-temperature resistant, and has a closed-cell structure.

Integral with the divider wall 224 which separates the left partition central compartment from the left partition lower compartment, on one hand, and the right partition central compartment from the right partition lower compartment on the other, are the thermoelectric Peltier coolers 230, with each having its cool side thereof oriented to face the respective lower compartment and the opposing hot side thereof oriented to face the respective central compartment. It is appreciated that when the thermoelectric Peltier cooler 230 is supplied with direct current electricity, it brings heat from one side to the other. Accordingly, the “cool side” of either thermoelectric Peltier cooler 230, as referenced herein, refers to the side of the thermoelectric Peltier cooler 230 from which heat is brought and the “hot side” of the thermoelectric Peltier cooler 230, as referenced herein, refers to the side of the thermoelectric Peltier cooler 230 to which heat is brought.

For the thermoelectric Peltier cooler 230 between the left partition central compartment from the left partition lower compartment (namely, the left partition thermoelectric Peltier cooler 230) a left partition cool side heat sink 231 is attached to the cool side and extends downward into the left partition lower compartment of the assembly housing 220. Similarly, for the thermoelectric Peltier cooler 230 between the right partition central compartment from the right partition lower compartment (namely, the right partition thermoelectric Peltier cooler 230) a right partition cool side heat sink 231 is attached to the cool side and extends downward into the right partition lower compartment of the assembly housing 220. In each of the left partition lower compartment, and the right partition lower compartment, a discrete cool side distribution fan 232 is positioned behind the cool side heat sink 231, so that when activated, it directs air across the respective cool side heat sink 231 which it is placed behind and out of the lower aspect of the front vent 221. It is contemplated that when either or both of the cool side distribution fans 232 are activated, it is primarily the air flowing into one or both of the side screens 222 (depending on whether one of both cool side distribution fans 232 are one) that enters the lower compartment that is being directed across the cool side heat sink 231 and out of the lower aspect of the front vent 221 by the cool side distribution fan 232.

On the hot side of each of the thermoelectric Peltier coolers 230, a discrete heat-transfer fluid system is integrated with, and runs between, the portion of the thermoelectric Peltier coolers 230 in the left partition and right partition central compartments, respectively, and the respective left partition and right partition hot side heat sinks 233 in the upper compartments. In this regard, the assembly housing 220 includes a left partition heat-transfer fluid system and a right partition heat-transfer fluid system. Each of these heat-transfer fluid systems include metal conduit system 251 having conduits which are positioned against the left partition or right partition thermoelectric Peltier cooler 230, run to and across the hot side heat sink 233 in the same partition (left or right), and run back to the portion of conduits which were positioned against the thermoelectric Peltier cooler 230, forming a closed loop. Disposed inside of the metal conduit system 251 is a heat-transfer fluid, such as water or other liquid coolant. Also integral with the heat-transfer fluid system is a pump 252 operative to receive electrical power from the battery 242 and pump the heat-transfer fluid through the closed loop of the heat-transfer fluid systems.

The heat-transfer fluid system in a given partition operates to absorb heat from the thermoelectric Peltier cooler 230 in that partition and transfer it to the hot side heat sink 233 in that partition where it can be absorbed. On each the left partition and right partition upper compartments, a hot side distribution fan 234 is positioned behind the hot side heat sink 233, so that when activated, it directs air across the given hot side heat sink 233 and out of the upper aspect of the front vent 221 on the side which the hot side heat sink 233 and hot side distribution fan 234 are on. It is contemplated that when a given hot side distribution fan 234 is activated, it is primarily the air flowing into the side screens 222 that enters the upper compartment that is being directed across the given hot side heat sink 233 and out of the upper aspect of the front vent 221 by the given hot side distribution fan 234.

The assembly panel 210 may be electrically connected to the assembly housing 220, and more particularly, to the charge controller 240 in the assembly housing 220. The charge controller 240 is electrically interconnected with the controller 241 and the battery 242 so that the charge controller 240 can manage the supply of electricity from the assembly panel 210 to the controller 241 and to the battery 242 and the storage of such electricity in the battery 242. In addition, the controller 241 is electrically connected to the thermoelectric Peltier coolers 230, cool side distribution fans 232, hot side distribution fans 234, intake fans 235, pump 252, switch 223, and the thermostat 250, and includes software containing instructions which enables it to selectively supply electricity from either the charge controller 240 or battery 242 either automatically, in response to a signal from the thermostat 250, or in response to a signal from the switch 223. It is appreciated that the electrical connections between components may be through electrical wiring (not shown).

The thermostat 250 operates to control whether the temperature control components in one, both or neither of the partitions are active in a given moment. In this regard, if the thermostat is set for a target temperature that is well below the current measured temperature, which may be greater than or equal to ten (10) degrees in some embodiments, then if the temperature modulation assembly 100 is active (by operation of the switch 223) then thermostat may send a signal to the controller to cause the temperature control components in both partitions to be active. On the other hand, if the thermostat is set for a target temperature that is close to the current measured temperature, which may be within ten (10) degrees (hotter or colder) in some embodiments, then if the temperature modulation assembly 100 is active (by operation of the switch) then thermostat may send a signal to the controller to cause the temperature control components in one partition to be active. Furthermore, if the thermostat is set for a target temperature that is well above the current measured temperature, which may be less than or equal to ten (10) degrees in some embodiments, then if the temperature modulation assembly 100 is active (by operation of the switch) then thermostat may send a signal to the controller to cause the temperature control components in both partitions to be inactive.

In operation, the temperature modulation assembly 200 in the second embodiment operates in a similar manner to that in the first embodiment, except that each of the left and right partitions may be operated independently using inputs from the thermostat. In some embodiments however, the controller 241 and switch 223 may alternatively be connected to allow for the left and right partitions to be controlled manually through single or multiple actuations of the switch 223. For example, a first actuation of the switch 223 may activate the left partition, a second may activate the right partition (with the left partition still on), a third may deactivate the left partition (with the right partition still on) and a fourth may deactivate the right partition (with the left partition still off).

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A temperature modulation assembly for a motor vehicle's passenger compartment, comprising:
an integrated power source;
an assembly housing defining an enclosure having a discrete lower internal compartment, a discrete upper internal compartment, a front region and a pair of opposing side regions;
at least one front vent integral with said front region, wherein at least a portion of said at least one front vent is positioned in front of the upper internal compartment and includes a plurality of upper fins which are angled upward and at least a portion of said at least one front vent is positioned in front of lower internal compartment and includes a plurality of lower fins which are angled downward;
at least one side screen integral with each of said pair of opposing side regions;
a thermoelectric Peltier cooler integral with said assembly housing and having a first side and a second side and configured to transfer heat from the first side to the second side when supplied with electricity that originated at the power source, wherein said thermoelectric Peltier cooler is oriented such that the first side is positioned in said lower internal compartment;
a heat-transfer fluid system integral with said second side, wherein the heat-transfer fluid system is configured to transfer heat from the second side to the upper internal compartment; and
a fluid distribution module integral with said assembly housing and adapted to (1) draw a fluid material into the assembly housing, (2) cause a first portion of said fluid material to enter the lower internal compartment to be cooled by operation of the first side of the thermoelectric Peltier cooler and directed out of the lower internal compartment and the assembly housing while passing through the lower fins, and (3) cause a second portion of said fluid material to enter the upper internal compartment to be heated by operation of the second side of the thermoelectric Peltier cooler and directed out of the upper internal compartment and the assembly housing while passing through the upper fins, all when said fluid distribution module is supplied with electricity that originated at the assembly panel.

2. The temperature modulation assembly for a motor vehicle's passenger compartment of claim 1, additionally comprising a cool side heat sink attached to the first side of the thermoelectric Peltier cooler.

3. The temperature modulation assembly for a motor vehicle's passenger compartment of claim 2, wherein said fluid distribution module includes a cool side distribution fan which causes the first portion of said fluid material to be cooled and directed out of the lower internal compartment and the assembly housing.

4. The temperature modulation assembly for a motor vehicle's passenger compartment of claim 3, additionally comprising a hot side heat sink integral with the heat-transfer fluid system and disposed in the upper internal compartment.

5. The temperature modulation assembly for a motor vehicle's passenger compartment of claim 4, wherein said fluid distribution module includes a hot side distribution fan which causes the second portion of said fluid material to be heated and directed out of the upper internal compartment and the assembly housing.

6. A temperature modulation assembly for a motor vehicle's passenger compartment, comprising:
an assembly panel configured to convert sunlight into electricity;
an assembly housing integral with said assembly panel and defining an enclosure having a discrete lower internal compartment, discrete central internal compartment, a discrete upper internal compartment, a front region and a pair of opposing side regions;
a front vent integral with said front region, wherein at least a portion of said front vent is positioned in front of upper internal compartment and includes a plurality of upper fins which are angled upward and at least a portion of said front vent is positioned in front of lower internal compartment and includes a plurality of lower fins which are angled downward;
at least one side screen integral with at least one of said pair of opposing side regions;
a thermoelectric Peltier cooler integral with said assembly housing and having a first side and a second side and configured to transfer heat from the first side to the second side when supplied with electricity that originated at the assembly panel, wherein said thermoelectric Peltier cooler is oriented such that the first side is positioned in said lower internal compartment and said second side is positioned in said central internal compartment;
a heat-transfer fluid system integral with said second side, wherein the heat-transfer fluid system is configured to transfer heat from the second side to the upper internal compartment; and
a fluid distribution module integral with said assembly housing and adapted to (1) draw a fluid material into the assembly housing, (2) cause a first portion of said fluid material to enter the lower internal compartment to be cooled by operation of the first side of the thermoelectric Peltier cooler and directed out of the lower internal compartment and the assembly housing while passing through the lower fins, and (3) cause a second portion of said fluid material to enter the upper internal compartment to be heated by operation of the second side of the thermoelectric Peltier cooler and directed out of the upper internal compartment and the assembly housing while passing through the upper fins, all when said fluid distribution module is supplied with electricity that originated at the assembly panel.

7. The temperature modulation assembly for a motor vehicle's passenger compartment of claim 6, additionally comprising a cool side heat sink attached to the first side of the thermoelectric Peltier cooler.

8. The temperature modulation assembly for a motor vehicle's passenger compartment of claim 7, wherein said fluid distribution module includes a cool side distribution fan which causes the first portion of said fluid material to be cooled and directed out of the lower internal compartment and the assembly housing.

9. The temperature modulation assembly for a motor vehicle's passenger compartment of claim 6, wherein said fluid distribution module includes a cool side distribution fan which causes the first portion of said fluid material to be cooled and directed out of the lower internal compartment and the assembly housing.

10. The temperature modulation assembly for a motor vehicle's passenger compartment of claim 6, additionally comprising a hot side heat sink integral with the heat-transfer fluid system and disposed in the upper internal compartment.

11. The temperature modulation assembly for a motor vehicle's passenger compartment of claim 10, wherein said fluid distribution module includes a hot side distribution fan which causes the second portion of said fluid material to be heated and directed out of the upper internal compartment and the assembly housing.

12. The temperature modulation assembly for a motor vehicle's passenger compartment of claim 6, wherein said fluid distribution module includes a hot side distribution fan which causes the second portion of said fluid material to be heated and directed out of the upper internal compartment and the assembly housing.

13. The temperature modulation assembly for a motor vehicle's passenger compartment of claim 6, additionally comprising a battery integral with said assembly housing and operative to store electricity that originated at the assembly panel.

14. The temperature modulation assembly for a motor vehicle's passenger compartment of claim 6, additionally comprising a charge controller operative to at least manage the supply of electricity from the assembly panel to the battery and the storage of such electricity in the battery.

15. The temperature modulation assembly for a motor vehicle's passenger compartment of claim 6, wherein said fluid distribution module includes at least one intake fan operative to draw the fluid material into the lower internal compartment and the upper internal compartment of the assembly housing.

16. A temperature modulation assembly for a motor vehicle's passenger compartment, comprising:
an assembly panel configured to convert sunlight into electricity;
an assembly housing integral with said assembly panel and defining an enclosure having a discrete lower internal compartment, a discrete upper internal compartment, a front region and a pair of opposing side regions;
a front vent integral with said front region, wherein at least a portion of said front vent is positioned in front of upper internal compartment and includes a plurality of upper fins which are angled upward and at least a portion of said front vent is positioned in front of lower internal compartment and includes a plurality of lower fins which are angled downward;
at least one side screen integral with at least one of said pair of opposing side regions;
a thermoelectric Peltier cooler integral with said assembly housing and having a first side and a second side and configured to transfer heat from the first side to the second side when supplied with electricity that originated at the assembly panel, wherein said thermoelectric Peltier cooler is oriented such that the first side is positioned in said lower internal compartment and said second side is positioned in said central internal compartment;
a heat-transfer fluid system integral with said second side, wherein the heat-transfer fluid system is configured to transfer heat from the second side to the upper internal compartment;
a fluid distribution module integral with said assembly housing and adapted to (1) draw a fluid material into the assembly housing, (2) cause a first portion of said fluid material to enter the lower internal compartment to be cooled by operation of the first side of the thermoelectric Peltier cooler and directed out of the lower internal compartment and the assembly housing while passing through the lower fins, and (3) cause a second portion of said fluid material to enter the upper internal compartment to be heated by operation of the second side of the thermoelectric Peltier cooler and directed out of the upper internal compartment and the assembly housing while passing through the upper fins, all when said fluid distribution module is supplied with electricity that originated at the assembly panel;
a cool side heat sink attached to the first side of the thermoelectric Peltier cooler;
a hot side heat sink integral with the heat-transfer fluid system and disposed in the upper internal compartment; and
a battery integral with said assembly housing and operative to store electricity that originated at the assembly panel.

17. The temperature modulation assembly for a motor vehicle's passenger compartment of claim 16, wherein said fluid distribution module includes a cool side distribution fan which causes the first portion of said fluid material to be cooled and directed out of the lower internal compartment and the assembly housing.

18. The temperature modulation assembly for a motor vehicle's passenger compartment of claim 17, wherein said fluid distribution module includes a hot side distribution fan which causes the second portion of said fluid material to be heated and directed out of the upper internal compartment and the assembly housing.

19. The temperature modulation assembly for a motor vehicle's passenger compartment of claim 18, wherein said fluid distribution module includes at least one intake fan operative to draw the fluid material into the lower internal compartment and the upper internal compartment of the assembly housing.

20. The temperature modulation assembly for a motor vehicle's passenger compartment of claim 16, additionally comprising a charge controller operative to at least manage the supply of electricity from the assembly panel to the battery and the storage of such electricity in the battery.
